(19) United States
(12) Patent Application Publication
(10) Pub. No.: US 2017/0101916 A1
(43) Pub. Date: Apr. 13, 2017

(54) METHOD FOR OPERATING AN INTERNAL COMBUSTION ENGINE, CONTROL DEVICE AND INTERNAL COMBUSTION ENGINE

(71) Applicant: MTU FRIEDRICHSHAFEN GMBH, Friedrichshafen (DE)

(72) Inventors: Philipp KLAAS, Friedrichshafen (DE); Daniel CHATTERJEE, Lindau (AT); Marc HEHLE, Konstanz (DE); Norbert MARKERT, Markdorf (DE); Ralf MÜLLER, Deggenhausertal (DE)

(21) Appl. No.: 15/129,324

(22) PCT Filed: Feb. 4, 2015
(86) PCT No.: PCT/EP2015/000219

§ 371 Date: Sep. 26, 2016

(30) Foreign Application Priority Data
Mar. 26, 2014 (DE) 10 2014 205 685.3

(51) Int. Cl. F01N 11/00; F01N 3/023; F02D 41/02; F01N 9/00

(52) U.S. Cl. CPC F01N 11/002; F01N 9/002; F01N 3/023; F02D 41/029; F01N 2550/04; F01N 2900/1406

(57) ABSTRACT

A method for operating an internal combustion engine with an exhaust gas after treatment system, which includes at least one particulate filter. The method is characterized by a parameter-controlled partial regeneration of the particulate filter.

The invention relates to a method for operating an internal combustion engine according to claim 1, a control device for an internal combustion engine according to claim 14, and an internal combustion engine according to claim 15.

Methods for operating internal combustion engines which have an exhaust gas after-treatment system with a particle filter are known. In this context, the particle filter takes up soot particles from the exhaust gas of the internal combustion engine and thereby reduces the particle concentration in the exhaust gas which is ultimately discharged. If a soot burn-off rate which occurs in the particle filter in the normal operating mode of the internal combustion engine is not sufficient to regenerate said particle filter, an active regeneration measure is carried out in order to regenerate the particle filter, for example by raising the exhaust gas temperature or increasing the nitrogen dioxide concentration in the exhaust gas. Within the scope of such a regeneration measure, complete regeneration of the particle filter, specifically as far as possible complete burning off of all the soot collected in the particle filter is aimed at. This is intended to bring about a defined initial state for the further operation of the particle filter, specifically an unloaded state. However, it is clear that at the start of the loading of an unladen particle filter with soot, pores of a filter substrate are firstly occupied by soot particles, which is also referred to as depth filtration. Since the pores provide flow paths for the exhaust gas through the particle filter, the depth filtration brings about a very rapid rise in a differential pressure which drops across the particle filter. Only when the pores are filled with soot particles does the soot also accumulate on the surface of the substrate to form a soot cake, which is referred to as surface filtration. This brings about a further, but somewhat moderate, rise in the differential pressure. In particular the depth filtration is therefore responsible for the differential pressure which drops across the particle filter and which constitutes a counter-pressure for the internal combustion engine and has an effect on the fuel consumption. This is particularly disadvantageous in the case of a particle filter whose substrate has a functional coating, for example a selectively catalytically reducing coating (SCR coating) for reducing nitrogen oxides in the exhaust gas or an oxidatively acting coating for oxidizing carbon monoxide (CO), hydrocarbons or nitrogen monoxide (NO). In such a particle filter, also referred to as an SDPF or cDPF or DDPF, the depth filtration also results in a significantly higher counter-pressure compared to an uncoated particle filter, which constitutes a decisive disadvantage of this combined technology comprising particle filtration, on the one hand, and selective catalytic reduction or oxidation catalysis, on the other. If the particle filter is completely regenerated, after the conclusion of the regeneration the depth filtration starts again, with the problem outlined above persisting.

The invention is therefore based on the object of providing a method which avoids the specified disadvantages. Furthermore, the invention is based on the object of providing a control device and an internal combustion engine in which the specified disadvantages do not occur.

The object is achieved by providing a method for operating an internal combustion engine having the features of claim 1. In this context, the internal combustion engine has an exhaust gas after-treatment system having at least one particle filter. The method is distinguished by the fact that partial regeneration of the particle filter is carried out under parameter control. If the filter is regenerated, both the soot particles which have been deposited on the surface in the form of a soot cake and the soot particles which are arranged in the pores of the substrate through which exhaust gas flows are burnt. However, it becomes apparent that very much less soot, in particular approximately 5 to 20% of the entire soot load of the particle filter, is present in the pores, while the rest of the soot, in particular approximately 80 to 95% of the soot particles, are deposited on the surface. Therefore, in the course of the regeneration the pores are freed of soot very much earlier than the surface of the substrate. Therefore, if partial regeneration is carried out, the soot which is deposited in the pores can in particular be burnt, wherein the soot cake is retained on the surface, at least partially, preferably mainly. After the conclusion of the regeneration, when the particle filter is loaded again depth filtration does not take place, or only to a small degree, because the soot cake which is still present on the surface protects the pores against the ingress of soot particles. At the same time, the soot cake improves the filtering performance of the filter, it being possible for the filter efficiency to rise, for example, in comparison to 95% given an entirely unloaded particle filter to far above 99% as a result of the soot cake. This means a number of particles reduced by a factor of up to 1000 in the discharged exhaust gas. The partially regenerated particle filter therefore has a higher filter efficiency than an unloaded particle filter. At the same time, the differential pressure drops to a significantly lower level because the pores are free of soot particles, with the result that exhaust gas can flow through them unimpeded. The partial regeneration therefore exhibits a significant hysteresis effect over the soot load, on the one hand, with respect to the filtration efficiency and, on the other hand, with respect to the differential pressure, which is advantageous both for the operation of the particle filter and for the operation of the internal combustion engine.

As a result of the control of the parameters for the partial regeneration it is possible to ensure that the soot particles deposited in the pores of the particle filter are removed as completely as possible, it being ensured at the same time that complete regeneration is not inadvertently carried out with the removal of the soot cake. In this context, the term “parameter-controlled” is intended to be understood as meaning both parameter-dependent open-loop control and parameter-dependent closed-loop control.

In one preferred embodiment of the method, the partial regeneration is carried out by increasing an exhaust gas temperature and/or a temperature of the particle filter. This accelerates soot oxidation which is based on the residual oxygen content of the exhaust gas. The increase in temperature can be implemented by heating the particle filter and/or an exhaust gas line, for example with an external burner, an electric heater, or by heating the exhaust gas by making exothermy available, for example by means of oxidation of fuel separately injected into the exhaust gas line or as late post-injection into a combustion chamber of the internal combustion engine, at an oxidation catalytic converter which is arranged upstream of the particle filter. What are referred to as passive regeneration measures for accelerating nitrogen-dioxide-assisted soot oxidation are also possible, for example by reducing or shutting down metering of the reducing agent upstream of an SCR (Selective Catalytic Reduction) catalytic converter or of the particle filter which is coated with an SCR catalytic material, by raising the exhaust gas temperature by means of suitable thermal management of the internal combustion engine by increasing the nitrogen dioxide yield by increasing the quantity of noble metal in an oxidation catalytic converter arranged upstream of the particle filter and/or by increasing the raw emission of nitrogen oxide by the internal combustion engine, in particular by means of suitable engine-internal measures. Such measures are known per se, and more details will therefore not be given on them here. It is important that the measures are carried out under parameter control in such a way that partial regeneration of the particle filter takes place according to demand, with the previously explained hysteresis effect coming into play.

One embodiment of the method in which a particle filter with a functional coating is used is particularly preferred. The functional coating is preferably a selectively catalytically reducing coating for reducing nitrogen oxides, or an oxidation catalytic coating, also referred to as DOC coating, for oxidizing CO, hydrocarbons or NO. Therefore, what is referred to as an SDPF or a particle filter with SCR coating or what is referred to as a DDPF, that is to say a particle filter with oxidation coating, is preferably used. In the case of a functionally coated particle filter, the hysteresis effect which is associated with the partial regeneration is particularly pronounced, wherein, in particular, the differential pressure level can be lowered to a greater extent by partial regeneration than is the case in a particle filter without functional coating. The advantage which is associated with the partial regeneration is therefore more strongly pronounced in a coated particle filter than in an uncoated particle filter. As a result, in particular in the case of an internal combustion engine which has such a coated particle filter, the method can be used to optimize the differential pressure behavior and therefore the fuel consumption. Under certain circumstances, this is what makes the efficient use of a particle filter with SCR coating or DOC coating at all possible, as a result of which replacement of a serial arrangement of the particle filter and a corresponding catalytic converter becomes economic in the first place. The combination of these two elements in an integrated element provides significant advantages in terms of costs, installation space and the attainment of the light-off temperature of the SCR catalytic material for reducing nitrogen oxide or the DOC coating for the CO oxidation, hydrocarbon oxidation or NO oxidation. These advantages are in turn ultimately made accessible by the method proposed here by making economic operation of a functionally coated particle filter possible.

One embodiment of the method is also preferred which is distinguished by the fact that the differential pressure which drops across the particle filter is detected, wherein the partial regeneration of the particle filter is carried out if the differential pressure reaches or exceeds a predetermined upper pressure limiting value, wherein the partial regeneration is open-loop or closed-loop controlled as a function of the differential pressure. The differential pressure is in this respect used as a parameter for the parameter-controlled partial regeneration of the particle filter. This permits very simple and cost-effective implementation of the method, in particular because typically a sensor device for detecting the differential pressure in the exhaust gas after-treatment system is provided in any case, and can be used within the scope of the method.

The differential pressure is preferably measured using a differential pressure sensor which, in a manner known per se, determines a pressure difference between a first measurement point directly upstream of the particle filter and a second measurement point directly downstream of the particle filter. Alternatively, it is possible for the sensor device for detecting differential pressure to have two pressure sensors, wherein a first pressure sensor is arranged directly upstream of the particle filter, and a second pressure sensor is arranged directly downstream of the particle filter. The differential pressure is then calculated as the difference between the pressure values which are detected by the two pressure sensors.

The differential pressure is preferably used as a measure of a load of the particle filter. In this context, a differential pressure model is preferably used which has load values for the particle filter as a function of the differential pressure, for example in the form of a characteristic diagram, or by means of which load values for the particle filter can be calculated from the differential pressure in accordance with a formula. The predetermined upper pressure limiting value preferably corresponds in this respect to a limiting load of the particle filter which should not be exceeded, in order to ensure uninterrupted operation of the internal combustion engine.

The partial regeneration can be open-loop or closed-loop controlled as a function of the differential pressure, since this parameter depends particularly sensitively on a soot particle load of the pores. It is therefore possible to establish on the basis of the differential pressure whether the particle regeneration is concluded.

One embodiment of the method is preferred which is distinguished by the fact that the particle regeneration is ended if the differential pressure reaches or undershoots a predetermined lower pressure limiting value. The predetermined lower pressure limiting value is preferably defined here in such a way that it defines a limit for the successfully concluded partial regeneration, wherein further lowering of the differential pressure level would no longer be attributable to the burning off of soot particles deposited in pores of the filter substrate but rather to removal of the surface soot cake. This ensures that the partial regeneration is, on the one hand, carried out as completely as possible, while, on the other hand, the soot cake on the surface of the filter substrate is at least retained to such an extent that improved filter efficiency occurs for the filter particle compared to the unloaded state, and renewed depth filtration is avoided by screening the pores of the filter substrate by means of the soot cake. Overall, the method can be implemented simply and precisely at the same time because it is readily possible to define in a suitable way both the upper pressure limiting value and the lower pressure limiting value. These can, for example, be calculated or determined using test bench trials.

An embodiment of the method is also preferred which is distinguished by the fact that a load of the particle filter is determined, wherein the partial regeneration is carried out if the load reaches or exceeds a predetermined upper load limiting value. In this respect, in this embodiment of the method the load of the particle filter is used as a parameter for the parameter-controlled partial regeneration. It is possible that the load is determined from the detected differential pressure, for example on the basis of a characteristic diagram or by calculation on the basis of a formula. However, an embodiment of the method is also preferred in which the load is determined independently of the differential pressure. It is possible here for the load of the particle filter to be determined on the basis of a load model which depends on at least one operating parameter of the internal combustion engine. In this context, in particular engine-internal parameters such as, for example, a rotational speed, a load, an injected fuel quantity, a combustion chamber temperature, a combustion chamber pressure, an exhaust gas recirculation rate, a fresh mass, a lambda value, a nitrogen oxide concentration, an exhaust gas volume flow or an exhaust gas mass flow are possible. Alternatively or additionally, an exhaust gas temperature, a nitrogen oxide concentration, a nitrogen dioxide formation rate or a soot concentration are possible as measured values or data from a characteristic diagram. Of course, more than one parameter can be used to determine the load, in particular a combination of at least two of the abovementioned parameters. These engine-internal parameters are characteristic of soot formation in the internal combustion engine and therefore supply—in particular considered as a function of time—a measure of the load of the particle filter. Alternatively or additionally, it is also possible to measure the load of the particle filter, for which purpose a high frequency sensor is preferably used. It is apparent that the use of the load as a parameter for open-loop or closed-loop control of the partial regeneration of the particle filter can be more precise than a purely differential-pressure-based open-loop or closed-loop control.

The partial regeneration is preferably ended if the load reaches or undershoots a predetermined lower load limiting value. In this context, the lower load limiting value is in turn preferably defined in such a way that as far as possible complete removal of soot particles from the pores of the filter substrate is ensured, wherein at the same time the surface soot cake is retained at least to such an extent that the filter efficiency of the particle filter is improved compared to the unloaded state, and the pores are protected against renewed depth filtration. In this way, the method can be implemented very precisely.

The predetermined lower pressure limiting value and/or the predetermined lower load limiting value are preferably also selected in such a way that the differential pressure and thus the counter-pressure for the exhaust gas flow at the particle filter are set in a region which is optimum for the operation of the internal combustion engine. In this way, the internal combustion engine can be operated very efficiently and, in particular, with significantly lower fuel consumption.

An embodiment of the method is also preferred which is distinguished by the fact that both the load and the differential pressure are used as parameters for the open-loop or closed-loop control of the partial regeneration. In this context, the load is particularly preferably determined independently of the differential pressure, specifically either measured or calculated using a load model as a function of at least one operating parameter of the internal combustion engine. In this way, complementary information on the differential pressure, on the one hand, and on the load model, on the other, is available, which considerably improves the accuracy of the method. The partial regeneration can therefore be open-loop or closed-loop controlled very precisely. In this context, characteristic diagrams and/or functions are preferably used which link, in particular, the load of the particle filter to the differential pressure for various partial loads, with the result that definitive information is contained about the location and the quantity of the deposited soot. It is therefore possible to determine very precisely the quantity of soot with which the particle filter is loaded overall and where the soot is arranged, specifically as soot cake on the surface of the substrate or else instead as soot particles in the pores. In particular, closed-loop control of the partial regeneration is therefore possible with a high level of accuracy.

It is possible that further and/or other parameters are used to perform open-loop or closed-loop control of the partial regeneration. In this context, at least one additional parameter and/or other parameter are preferably used to perform open-loop or closed-loop control of the partial regeneration.

An embodiment of the method is also preferred which is distinguished by the fact that plausibility checking is carried out subsequent to the partial regeneration. In this context, complete regeneration of the particle filter is carried out if the plausibility checking returns a negative result. In particular, within the scope of the plausibility checking it is preferably checked whether the pores of the particle filter are still sufficiently free of soot particles or whether renewed depth filtration has already taken place. The soot cake on the surface of the substrate can, in fact, only in an ideal case completely prevent soot particles from penetrating the pores, with the result that over the course of time depth filtration—even if delayed—takes place. In order to test this, within the scope of the plausibility checking, combined consideration is preferably made of the load which is determined independently of the differential pressure—being, for example, calculated or measured—with the value of the differential pressure. In this context it becomes apparent whether these values still lie in a value range which corresponds to essentially surface depositing of soot on the particle filter or whether the differential pressure level when loading has occurred is already in a range which indicates depth filtration. When loading has occurred, the differential pressure level is in fact significantly higher if soot particles are deposited in pores than if the pores are free. If, in this respect, it is detected within the scope of the plausibility checking that depth filtration has taken place or has started, the particle filter is preferably completely regenerated in order to bring about a defined initial state again.

This is followed again by a phase of depth filtration, which is in turn adjoined by a phase of surface filtration. If the predetermined upper pressure limiting value or the predetermined upper load limiting value is then in turn exceeded, partial regeneration can be carried out again, as a result of which the method starts again, as it were.

An embodiment of the method is also preferred which is distinguished by the fact that after starting the method first partial regeneration is initially carried out if the differential pressure reaches or exceeds a first higher upper pressure limiting value, wherein subsequent partial regeneration processes are carried out if the differential pressure reaches or exceeds a second lower upper pressure limiting value. The first upper pressure limiting value is therefore higher than the second upper pressure limiting value. The term start of the method is understood here to mean the initial execution of the method in the new state of the particle filter or in the completely regenerated state of the particle filter, at any rate therefore the initial execution of the method with an unloaded particle filter. In this case, depth filtration takes place firstly, wherein the differential pressure level rises rapidly. The phase of depth filtration is adjoined by the phase of surface filtration, wherein in this phase only a moderate rise in the differential pressure level takes place. The differential pressure level is, however, at a comparatively high level as a result of the depth filtration which has taken place. Therefore, the partial regeneration in the case of loading of the new or completely regenerated and, in this respect, unloaded particle filter is not carried out until the first, higher upper pressure limiting value is reached or exceeded. After partial regeneration has taken place, the differential pressure level is very much lower owing to the free pores of the substrate and the filter effect of the soot cake for a given load of the particle filter than is the case subsequent to the depth filtration. Therefore, a lower differential pressure level corresponds to a certain load of the particle filter. Renewed partial regeneration is therefore carried out if the differential pressure reaches or exceeds the second, lower upper pressure limiting value. In this context, the two upper pressure limiting values preferably correspond to one another insofar as they correspond to an identical absolute soot load of the particle filter, wherein only the soot distribution in the particle filter differs: the first, higher upper pressure limiting value is relevant in a state in which the soot is deposited in the substrate pores and on the surface wherein the second, lower upper pressure limiting value is relevant in a state in which the pores are at least largely free of soot particles.

An embodiment of the method is also preferred which is distinguished by the fact that the plausibility checking is carried out if a first load value is determined for the particle filter on the basis of the differential pressure—preferably calculated in accordance with a formula or read out form a characteristic diagram, wherein a second load value is determined independently of the differential pressure. The first and the second load values are compared with one another. A soot distribution in the particle filter can be inferred on the basis of the two values. While the differential-pressure-independent load value typically predicts the absolute load of the particle filter with a comparatively small error, the differential-pressure-based load value tends to overestimate the load if soot particles are arranged in the pores of the filter substrate and in this respect the pores are partially subjected to wear. A deviation between the two load values therefore indicates deposition of soot in the pores and in this respect depth filtration.

An embodiment of the method is preferred in which the load value which is determined independently of the differential pressure is measured—preferably using a high frequency sensor—or is calculated on the basis of a load model as a function of at least one operating parameter of the internal combustion engine. As already previously stated, in this way the overall soot load of the particle filter can be determined very precisely.

An embodiment of the method is also preferred which is distinguished by the fact that the plausibility checking supplies a negative result if an absolute difference between the first load value and the second load value exceeds a predetermined differential limiting value. A difference of the load values is therefore formed, wherein the absolute value thereof is considered. If said absolute value reaches or exceeds the predetermined differential limiting value, it is assumed that a depth filtration has taken place or the pores of the substrate are loaded with soot particles. This can be inferred because the differential-pressure-based load value tends to overestimate the actual load of the particle filter if a depth filtration has taken place, while the differential-pressure-independent load value permits comparatively fault-free prediction of the absolute soot load of the particle filter.

As an alternative to its differential formation and/or to a direct comparison of the two load values, it is also possible to compare these values which are stored in characteristic diagrams in order to carry out the plausibility checking.

Finally, an embodiment of the method is preferred which is distinguished by the fact that a soot burn-off rate is included in the open-loop or closed-loop control of the partial regeneration. Alternatively or additionally, it is possible for the soot burn-off rate to be included in the plausibility checking. Typically, a method for calculating a soot burn-off rate is implemented in a control device of the internal combustion engine. The accuracy of the method can be increased if it is also taken into account in the open-loop or closed-loop control of the partial regeneration and/or in the plausibility checking.

The object is also achieved by providing a control device having the features of claim 14. Said device is configured to carry out a method for operating an internal combustion engine according to one of the embodiments described above. In this context, the advantages which have already been explained in relation to the method are obtained in conjunction with the control device.

It is possible that the method is fixedly implemented in an electronic structure, in particular a hardware structure, of the control device. Alternatively, it is preferably provided that a computer program product is loaded into the control device, which product has instructions on the basis of which the method can be carried out when the computer program product is executed on the control device.

The control device is preferably integrated into a control device of the internal combustion engine (engine control unit—ECU) or is embodied as a control device for the internal combustion engine. In particular, it is possible that the method is implemented in the form of an additional module or an additional method into the control device of the internal combustion engine. This is particularly advantageously possible because the control device of the internal combustion engine in any case typically has operative connections and/or interfaces for detecting the various parameters used within the scope of the method, and furthermore typically also in any case has characteristic diagrams or models for the differential-pressure-based and/or differential-pressure-independent calculation of a load of the particle filter. However, said characteristic diagrams or models are preferably expanded with respect to their functionality in order to carry out the method.

Alternatively, it is possible that the control device is embodied as a separate control device for carrying out the method. In this case it is preferably operatively connected to the control device of the internal combustion engine in order, for example, to be able to exchange information about operating parameters of the internal combustion engine and/or measured values present in the control device of the internal combustion engine. Alternatively it is also possible if the control device is completely separate, wherein dedicated corresponding operative connections and/or interfaces of the sensors which are addressed within the scope of the method are then necessary, and wherein models and/or characteristic diagrams which are required within the scope of the method are implemented in the control device.

The control device is preferably distinguished by at least one feature which is conditioned by at least one method step of the method.

Finally, the object is achieved by providing an internal combustion engine having the features of claim 15. Said internal combustion engine is distinguished by a control device as claimed in one of the exemplary embodiments described above. In this respect, the advantages which have already been explained in conjunction with the control device and the method are obtained in conjunction with the internal combustion engine.

The internal combustion engine is preferably configured as a reciprocating piston engine. In one preferred exemplary embodiment the internal combustion engine is used in a passenger car or a utility vehicle, for example a truck wherein, in particular, it serves to drive such a motor vehicle. In another preferred exemplary embodiment, the internal combustion engine serves to drive, in particular, heavy land vehicles or watercraft, for example mining vehicles and trains, wherein the internal combustion engine is used in a locomotive or a tractive unit, or to drive ships. A use of the internal combustion engine to drive a vehicle serving for defense, for example a tank, is also possible. An exemplary embodiment of the internal combustion engine is preferably also used in a stationary fashion, for example for the stationary energy supply in the emergency power mode, continuous load mode or peak load mode, wherein in this case the internal combustion engine preferably drives a generator. A stationary application of the internal combustion engine for driving auxiliary units, for example fire extinguishing pumps on drilling rigs, is also possible. Furthermore, an application of the internal combustion engine within the scope of the extraction of raw fossil materials and, in particular, fuels, for example oil and/or gas, is possible. The use of the internal combustion engine in an industrial field or in the field of construction, for example in a construction machine or building machine, for example in a crane or an excavator, is also possible. The internal combustion engine is preferably embodied as a diesel engine or as a petrol engine.

The invention will be explained in more detail below with reference to the drawing, in which:

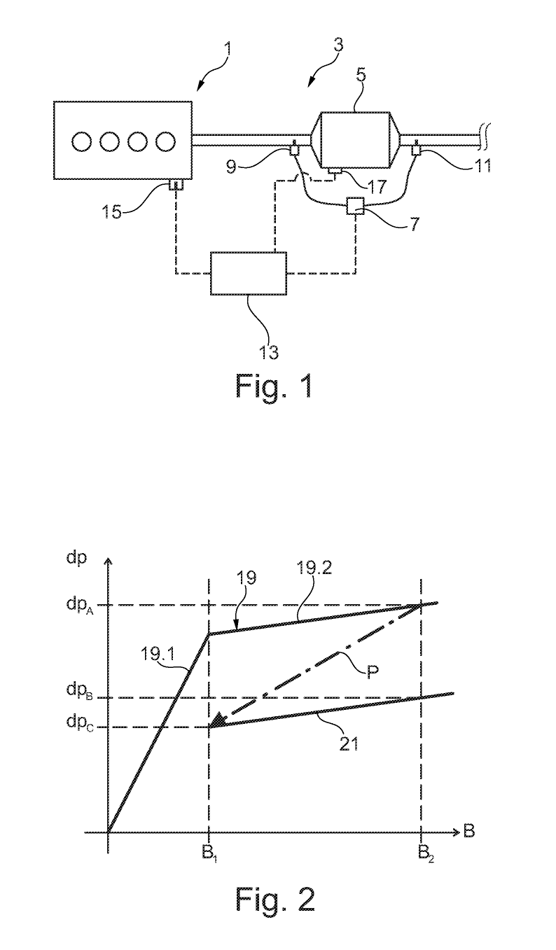

FIG. 1 shows a schematic illustration of an exemplary embodiment of an internal combustion engine;

FIG. 2 shows a schematic illustration of the dependence of the differential pressure across the partial filter of the load of said filter, and

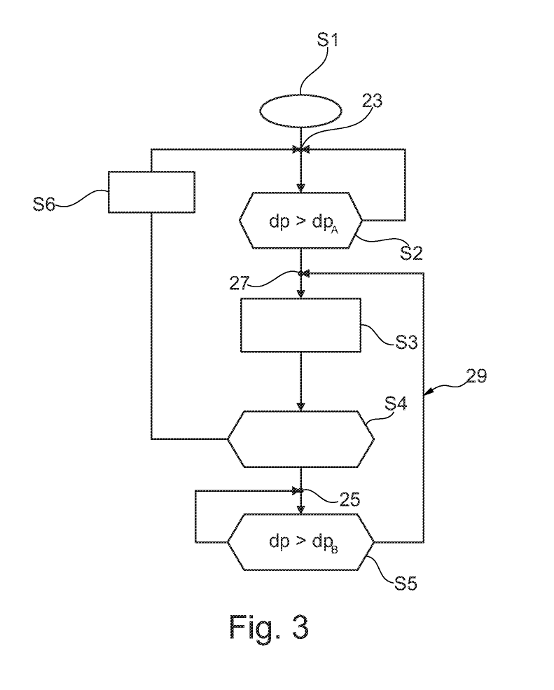

FIG. 3 shows a schematic illustration of an embodiment of the method in the form of a flowchart.

FIG. 1 shows a schematic illustration of an exemplary embodiment of an internal combustion engine 1 having an exhaust gas after-treatment system 3. The latter has a particle filter 5 which itself preferably has a functional coating, preferably a coating with a selectively catalytically reducing effect (SCR coating) or an oxidatively acting coating (DOC effect). The particle filter 5 is in this respect preferably embodied as what is referred to as an SDPF or cDPF or DDPF.

In order to measure a differential pressure which drops across the particle filter 5 in the exhaust gas after-treatment system 3, in the exemplary embodiment illustrated here a differential pressure sensor 7 is provided which measures the pressure difference between the pressure at a location of a first measuring point 9, which is provided directly upstream of the particle filter 5, and the pressure at the location of a second measuring point 11, which is provided directly downstream of the particle filter 5. Alternatively, it is possible that a pressure sensor is preferably provided at each of the locations of the first and second measuring points 9, 11, wherein the differential pressure is determined by forming differences between the measured values of the two pressure sensors.

A control device 13 is provided which is configured to carry out a method for operating the internal combustion engine 1, wherein parameter-controlled partial regeneration of the particle filter 5 is carried out. For this purpose, the control device 13 is operatively connected to the differential pressure sensor 7 in order to detect the differential pressure. Furthermore, it is operatively connected to a sensor device 15 which is configured and arranged so as to detect at least one operating parameter of the internal combustion engine 1. The latter is preferably used in the control device 13 to determine a load of the particle filter 5 which can be determined independently of the differential pressure.

Alternatively or additionally, the control device 13 is preferably operatively connected to a load sensor 17 which is configured to determine a load of the particle filter 5, wherein the load sensor 17 is preferably based on high-frequency technology.

The control device 13 is therefore configured to detect the differential pressure and preferably to determine a load of the particle filter 5 as a function of the differential pressure, in particular on the basis of a characteristic diagram or on the basis of a differential-pressure-dependent load model, preferably by calculating according to a formula. The control device 13 is preferably alternatively or additionally designed to detect a load of the particle filter independently of the differential pressure, in particular on the basis of a load model which depends on at least one operating parameter of the internal combustion engine 1, and/or by measuring by means of the load sensor 17. The control device 13 is configured to perform partial regeneration of the particle filter under open-loop or closed-loop control using the load—preferably determined independently of the differential pressure—and/or the differential pressure as parameters. Furthermore, the control device 13 is preferably configured to carry out plausibility checking and to carry out complete regeneration of the particle filter if the plausibility checking returns a negative result. Overall, the control device is preferably configured to carry out one of the embodiments of the method described above.

The control device 13 is preferably embodied as a control device of the internal combustion engine 1 or integrated therein. Alternatively it is possible that the control device 13 is provided as a separate control device.

FIG. 2 shows a schematic diagrammatic illustration with a differential pressure dp which drop drops across the particle filter 5, as a function of a load B of the particle filter 5. In this context, a first unbroken curve 19 represents the profile of the differential pressure dp as a function of the load B for an unloaded particle filter 5, in particular for a new or previously completely regenerated particle filter 5. In this context it becomes apparent that a comparatively large gradient of the differential pressure dp is firstly present in a first region 19.1 of the curve 19 as a function of the load B. This is the region in which depth filtration takes place, where pores of the filter substrate are loaded with soot particles. Given a specific load B₁, the depth filtration is concluded, the pores are filled with soot and the latter is precipitated on the surface of the wall of the filter substrate to form a soot cake, which is also referred to as surface filtration. This brings about a further, but now somewhat moderate, rise in the differential pressure level dp with a relatively small gradient in a second region 19.2 of the curve 19.

If a first higher upper pressure limiting value dp_{A} is reached, the particle filter 5 has a load B₂. In this context, the first upper pressure limiting value dp_{A} is preferably selected in such a way that the load B₂ corresponds to a specific limiting load of the particle filter 5 at which the latter should be regenerated in order to ensure fault-free operation of the internal combustion engine 1.

If the particle filter 5 is now completely regenerated, a new load cycle then starts at the origin of the diagram according to FIG. 2 along curve 19. Therefore, firstly depth filtration takes place again and subsequently surface filtration, wherein overall a very high differential pressure level is reached at which the internal combustion engine 1 has a comparatively high fuel consumption. This is the case, in particular, when the particle filter 5 has a functional coating.

In contrast, with a dot-dash arrow P it is illustrated how the differential pressure dp and the load B behave in the case of partial regeneration of the particle filter 5. In this context, in particular the soot which is arranged in the pores is burnt. The partial regeneration is preferably ended if the differential pressure dp reaches a predetermined lower pressure limiting value dp_{C}. In this state, the pores of the filter substrate are at least largely free of soot, and at the same time, however, the wall of the substrate has a soot cake which significantly increases the filter efficiency of the particle filter 5 and protects the pores against the accumulation of new soot, therefore against depth filtration, by preventing soot particles from penetrating the pores. Therefore, starting from the lower pressure limiting value dp_{C}, which is preferably selected in such a way that the particle filter 5 has the load B₁ here, there is subsequent surface filtration along a second unbroken curve 21, which runs parallel to the second region 19.2 of the curve 19 at a significantly lower pressure level. The differential pressure level given the same load B of the particle filter 5 after the partial regeneration is therefore lower than is the case in the previously unloaded or completely regenerated state of the particle filter 5. In this respect, the particle filter 5 has—in particular as an SDPF, cDPF or DDPF—a significant hysteresis effect in the case of partial regeneration.

The lower pressure limiting value dp_{C} is preferably selected in such a way that it lies in a region which is optimum for the operation of the internal combustion engine 1.

If the curve 21 is considered, it becomes apparent that the load B₂ is now reached at a second relatively low upper pressure limiting value dp_{B}. If this is the case, the particle filter 5 is preferably partially regenerated again. In the ideal case, the point or the value pair dp_{C}, B₁, consequently the first load value B₁, is reached here again at the lower pressure limiting value dp_{C}.

In the course of time, it is, however, possible that depth filtration does indeed take place again, wherein the differential pressure level rises for a given load B. It may be the case here that the second curve 21 is offset upwardly in parallel and/or that its gradient becomes larger. In any case, the differential pressure dp rises for a given load B as the depth filtration increases.

This is checked within the scope of a plausibility check after each partial regeneration of the particle filter 5, wherein, at the latest, when the differential pressure dp is on the first curve 19 again for a given load B, complete regeneration of the particle filter 5 is carried out in order to reach a defined initial state.

Taking this as a starting point, the curve 19 is then initially run through again before the first, in this respect initial, partial regeneration is carried out again along the arrow P starting from the first upper pressure limiting value dp_{A}.

FIG. 3 shows a schematic illustration of an embodiment of the method in the form of a flowchart. The method starts in a first step S1. In an interrogation S2, it is checked whether the differential pressure dp is higher than the first higher upper pressure limiting value dp_{A}. Alternatively it is also possible to check here whether the differential pressure dp is higher than or equal to the first upper pressure limiting value dp_{A}. If this is not the case, that is to say, in particular, the differential pressure dp is lower than the first higher upper pressure limiting value dp_{A}, the method jumps back to a jump point 23, starting from which the interrogation S2 is carried out again.

This is repeated until the differential pressure dp is higher than or equal to the first upper pressure limiting value dp_{A}. If this is the case, in a third step S3 partial regeneration of the particle filter 5 is carried out. This is preferably ended when the differential pressure dp reaches or undershoots the lower pressure limiting value dp_{C}.

After this, in a fourth step S4 there is plausibility checking by means of which a load B of the particle filter 5, determined independently of the differential pressure dp, is preferably placed in relationship with the differential pressure dp. If FIG. 2 is considered, it becomes apparent that in this way it is clearly possible to establish whether the particle filter 5 is still operating in the region of the second curve 21, or whether renewed depth filtration has already started, in which case the differential pressure dp departs upwardly from the second curve 21 for a given load B.

The plausibility check in the step S4 is preferably carried out in accordance with one of the embodiments described above.

If the plausibility check returns a positive result, that is to say no loading, or at least no relevant loading, of the pores of the substrate having soot particles has taken place yet, the method is continued in an interrogation S5 in which it is checked whether the differential pressure dp is higher than the second lower upper pressure limiting value dp_{B}. Alternatively it is possible that in the interrogation S5 it is checked whether the differential pressure dp is higher than or equal to the second upper pressure limiting value dp_{B}. If this is not the case, the method jumps back to a jump point 25, and the interrogation S4 is carried out again. This procedure is repeated until the differential pressure dp is higher than or equal to the second upper pressure limiting value dp_{B}. If this is the case, the method jumps back to a jump point 27, and the partial regeneration of the particle filter 5 is carried out again in the step S3. The plausibility checking then in turn follows in the fourth step S4.

In this context, the following becomes clear: after the start of the method in the first step S1, first partial regeneration firstly initially takes place in the third step S3 if the differential pressure dp reaches or exceeds the first higher upper pressure limiting value dp_{A}. Subsequently, the method runs through a loop 29 in an iterative fashion as long as the plausibility checking returns a positive result. In this context, partial regeneration is then continuously carried out in the loop 29 if the differential pressure dp reaches or exceeds the second lower upper pressure limiting value dp_{B}.

If the plausibility checking in the fourth step S4 returns a negative result, in a sixth step S6 complete regeneration of the particle filter 5 is carried out. After the conclusion of the complete regeneration, the method jumps to the first jump point 23, which corresponds as it were to a restart of the method. This corresponds to the fact that after the complete regeneration the particle filter 5 is again in the unloaded state. Therefore, partial regeneration is carried out again if the differential pressure reaches or exceeds the first higher upper pressure limiting value dp_{A}.

Overall, it becomes apparent that the method permits particularly efficient and economical operation of a particle filter 5, in particular of a particle filter 5 with a functional coating, in particular with a SCR or DOC coating, wherein the method in fact makes use of this combined technology economical.

1-15. (canceled)

16. A method for operating an internal combustion engine with an exhaust gas after-treatment system that has at least one particle filter, the method comprising parameter-controlled partial regeneration of the particle filter.

17. The method according to 16, wherein the at least one particle filter has a functional coating.

18. The method according to claim 17, wherein the functional coating is a selectively catalytically reducing or an oxidatively acting coating.

19. The method according to claim 16, including detecting a differential pressure that drops across the particle filter, wherein the partial regeneration of the particle filter is carried out if the differential pressure reaches or exceeds a predetermined upper pressure limiting value, wherein the partial regeneration is open-loop or closed-loop controlled as a function of the differential pressure.

20. The method according to claim 19, including ending the partial regeneration when the differential pressure reaches or undershoots a predetermined lower pressure limiting value.

21. The method according to claim 19, including determining a load of the particle filter, wherein the partial regeneration is carried out when the load reaches or exceeds a predetermined upper load limiting value.

22. The method according to claim 21, including ending the partial regeneration when the load reaches or undershoots a predetermined lower load limiting value.

23. The method according to claim 21, including using the load and the differential pressure as parameters for the open-loop or closed-loop control of the partial regeneration.

24. The method according to claim 19, further including carrying out plausibility checking after the partial regeneration, wherein complete regeneration of the particle filter is carried out if the plausibility checking returns a negative result.

25. The method according to claim 19, wherein after starting the method a first partial regeneration is initially carried out if the differential pressure reaches or exceeds a first higher upper pressure limiting value, wherein subsequent partial regeneration processes are carried out if the differential pressure reaches or exceeds a second lower upper pressure limiting value.

26. The method according to claim 24, wherein the plausibility checking is carried out if a first load value is determined for the particle filter based on the differential pressure, wherein a second load value is determined independently of the differential pressure, wherein the first and the second load values are compared with one another.

27. The method according to claim 26, Wherein the second load value is measured or is calculated based on a load model as a function of at least one operating parameter of the internal combustion engine.

28. The method according to claim 26, wherein the plausibility checking returns a negative result if an absolute difference between the first and the second load values exceeds a predetermined differential limiting value.

29. The method according to claim 24, wherein a soot burn-off rate is included in the open-loop or closed-loop control of the partial regeneration and/or in the plausibility checking.

30. A control device for an internal combustion engine, wherein the control device is configured to carry out the method according to claim 16.

31. An internal combustion engine comprising a control device according to claim 30.
